(19) United States
(12) Patent Application Publication
(10) Pub. No.: US 2017/0053096 A1
(43) Pub. Date: Feb. 23, 2017

(54) NFC TO CUSTOMER PROFILE SYSTEMS AND METHODS

(71) Applicant: Wal-Mart Stores, Inc., Bentonville, AR (US)

(72) Inventors: Richard Andrew White, Pinevilel, MO (US); Jimmie R. Clark, Fayetteville, AR (US); Christopher Soames Johnson, Pea Ridge, AR (US)

(21) Appl. No.: 15/241,580

(22) Filed: Aug. 19, 2016

Related U.S. Application Data
(60) Provisional application No. 62/208,214, filed on Aug. 21, 2015.

(51) Int. Cl. G06F 19/00; H04L 29/08; G06Q 30/06

(52) U.S. Cl. CPC G06F 19/3456; G06Q 30/0627; G06Q 30/0643; G06Q 30/0631; H04L 67/306; G06F 19/323; G06F 19/326; G06F 19/3431

(57) ABSTRACT

Provided is a NFC to customer profile system and method for personalized shopping. The system includes a mobile NFC reading device comprising a memory and a processor. The memory stores a user profile having constraints and software logic. The system also includes an NFC tag corresponding to an item for sale. The NFC tag comprising item information of the item for sale and located adjacent to or on the item for sale. The mobile NFC reading device communicates with NFC tag to receive the item information. The processor of mobile NFC reading device executes the software logic to process the item information and compare the item information with the user profile. The mobile NFC reading device notifies a user in response to a determination that the item information is not within the constraints of the user profile. Further, the system operates without a network connection.

This application claims priority to U.S. Provisional Patent Application Ser. No. 62/208,214, filed on Aug. 21, 2015 entitled “NFC to Customer Profile Systems and Methods,” the entirety of which is incorporated by reference herein.

### FIELD OF THE INVENTION

The invention relates generally to shopping, and more specifically, to systems and methods for using near field communication (“NFC”) devices to compare data from a product with a customer profile while shopping.

### BACKGROUND

Customers are often faced with a variety of complicated purchasing constraints. Some of these constraints include diet, finances, allergies, prescriptions, and the like. Foods can have ingredients that interfere with prescription medications. Foods can have ingredients that cause allergy attacks that the buyer may not be aware of. Dietary restrictions such as dairy, wheat, religious constraints, and the like may cause purchase to be unusable. Finance restrictions may be a concern for some buyers, such as Women-Infant-Children program, food stamps, vouchers, or coupons. Other constraints include insurance information to prescriptions, security of personal information related to HIPPA, security of insurance information and security of financial information. Most customers have some type of constraint that they must account for during shopping.

### BRIEF SUMMARY

In one aspect, provided is a mobile NFC reading device comprising a memory and a processor, wherein the memory stores a user profile having constraints and software logic; and an NFC tag corresponding to an item for sale, the NFC tag comprising item information of the item for sale and located adjacent to or on the item for sale; wherein the mobile NFC reading device communicates with NFC tag to receive the item information; the processor of mobile NFC reading device executes the software logic to process the item information and compare the item information with the user profile; and the mobile NFC reading device notifies a user in response to a determination that the item information is not within the constraints of the user profile.

In another aspect, provided is a method of personalized shopping, the method comprising storing a user profile in a memory of a mobile NFC reading device, wherein the user profile includes constraints; establishing a communication between the mobile NFC device and an NFC tag coupled to an item for sale; receiving item information stored on the NFC tag by the mobile NFC reading device, wherein the item information corresponds to the item for sale; processing the item information received by the mobile NFC reading device, wherein processing the item comprises executing software logic stored in the memory of the mobile NFC reading device, and comparing the item information with the user profile; and notifying a user in response to a determination that the item information is or is not within the constraints of the user profile.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is an illustrative view of an NFC reading device of an NFC to customer system for personalized shopping, in accordance with some embodiments.

FIG. 2 is an illustrative view of an NFC to customer system for personalized shopping, in accordance with some embodiments.

FIG. 3 is a flow diagram illustrating a method of personalized shopping, in accordance with some embodiments.

### DETAILED DESCRIPTION

Many store customers have constraints that they must consider when shopping. The range of constraints include, but are not limited to, diet, finances, allergies, prescriptions, combinations thereof and the like. Typically, customers manage these in their own way using memory, written notes and other forms of reminding the customers what their constraints are. This becomes even more difficult when a customer is shopping for an entire household where different members of that household have differing constraints.

For example and without limitation, one member in a household may have a particular food allergy, another member may have recently started taking a particular medication that has a list of restrictions on dietary items, and another member may be trying to lose weight and have self-imposed dietary restrictions. Each of these constraints may be difficult to track and additionally, some of them change over time as prescriptions change and diets change. Further, many customers are concerned about the security of their information, particularly if there is medical and financial information that is a part of their constraints.

The present inventive provides the ability of the customer to store and update profile on a mobile device, such as a mobile NFC reading device, a smart phone with NFC capability and the like. The profile is stored locally on the NFC reading device and includes security measures, such as encryption and the like to prevent others from accessing the information. Further, the system will not utilize a network connection for operation and therefore is not subject to transmission of sensitive information over a network connection. This helps to conform to any HIPPA standards that may need to be implemented with embodiments of the present invention.

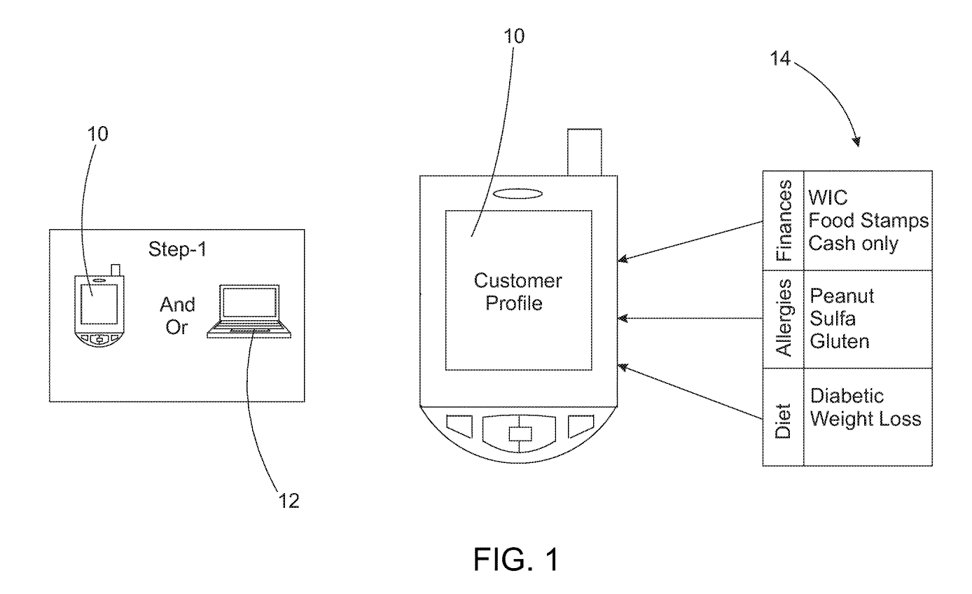

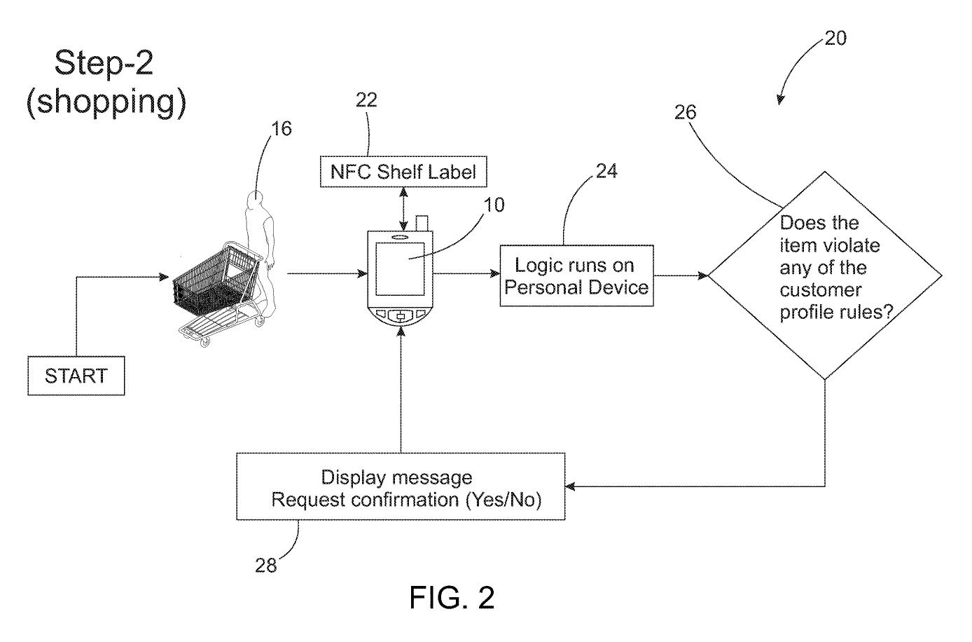

FIG. 1 is an illustrative view of an NFC reading device 10 of an NFC to customer system 20 (see FIG. 2) for personalized shopping, in accordance with some embodiments. In order to utilize the system 20, a user must first utilize the NFC reading device 10, such as a mobile NFC reading device, including, but not limited to a mobile computing device, a smart phone, a tablet and the like. The NFC reading device includes a memory and a processor. The memory stores software logic, wherein the mobile NFC reading device 10 may execute the software logic in order for a user to create a user profile 14 and store the user profile in the memory of the mobile NFC device 10. The user profile 14 may include constraints such as, but not limited to dietary constraints, allergy constraints and finances constraints. Dietary constraints may include without limitation diabetic user, weight loss and the like; allergy constraints may include without limitation peanut, tree nut, sulfa, gluten and the like; and finances constraint may include WIC, food stamps, cash only and the like. It will be understood that other constraints, such as prescription constraints, insurance constraints and the like may also be included in a user profile 14. The user profile 14 may be add using a computer 12 and then transferred to the mobile NFC reading device 10. In embodiments, the user profile 14 must be stored locally on the mobile NFC reading device 10 in order for the system 20 to operate.

In embodiments, the user profile 14 may include ingredients of food products that interfered with prescription medication; ingredients of food products that the user is allergic to; dietary restrictions; financial constraints; insurance information; current medications; religious constraints; and the like.

FIG. 2 is an illustrative view of an NFC to customer system 20 for personalized shopping in accordance with some embodiments. The system 20 may include the mobile NFC reading device 10 and an NFC tag 22. The NFC tag 22 corresponds to an item for sale. The NFC tag 22 includes item information of the item for sale and is located adjacent to or on the item for sale. The item for sale may be a food product, prescription medication, over the counter medication and the like.

When a customer 16 enter a store and starts use of the system 20, the customer 16 may utilize the NFC reading device 10 to communicate with the NFC tag 22 to receive the item information. The processor of mobile NFC reading device 10 executes the software logic to process the item information and compare the item information with the user profile 14 as represented by block 24 of FIG. 2. The processor of the mobile NFC reading device 10 executes the software logic locally on the mobile NFC reading device 10 without establishing a network connection. The processing of the software logic results in a determination as to whether the item information received from the NFC tag 22 violates the customer's user profile 14, as shown in decision block 26 of FIG. 2. Once a determination is made, the mobile NFC reading device 10 notifies a user in response the item information is not within the constraints of the user profile 14 as indicated is block 28 of FIG. 2. In some embodiments, the mobile NFC reading device 10 notifies a user in response to the item information being within the constraints of the user profile 14.

In embodiments, the mobile NFC reading device 10 operates independent of a network connection. Additionally, the NFC tag 22 operates independent of a network connection. Accordingly, the communication between the mobile NFC reading device 10 and the NFC tag 22 is directly between the two components thereby reducing the ability of others to intercept the information transmitted. Also, since the transmission of information is a one way transmission from the NFC tag 22 to the mobile NFC reading device 10, the only information that may be transmitted is item information. This reduces or eliminates the transmission of any information stored in memory under the user profile 14. This functions as a form of security of the information of the customer 16. In addition to these security measures, the user profile 14 may be encrypted on the memory of the mobile NFC reading device 10.

In some embodiments, the mobile NFC reading device 10 may display an alternative item on a display of the mobile NFC reading device 10 in response to the determination that the item information is not within the constraints of the user profile 14. This allows the customer 16 to obtain a similar product within the constraints without the need of looking and scanning several NFC tags 22.

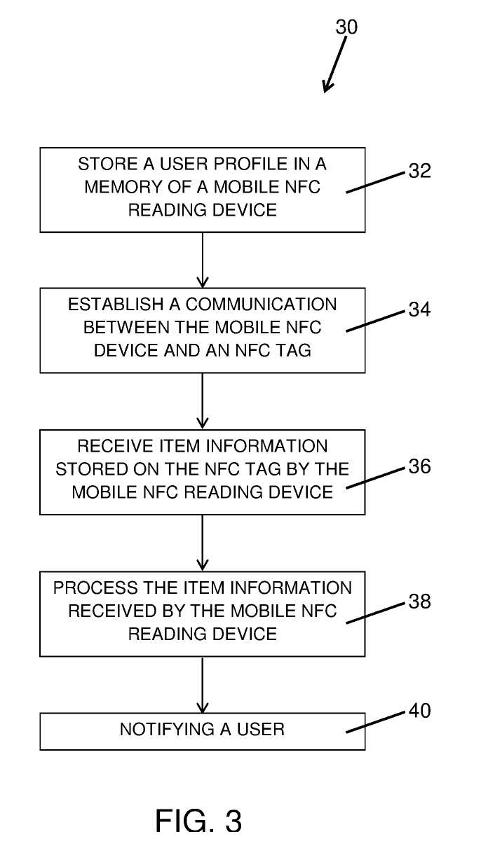

FIG. 3 is a flow diagram illustrating a method 30 of personalized shopping, in accordance with some embodiments. The method 30 may include Step 32 of storing a user profile 14 in a memory of a mobile NFC reading device 10, wherein the user profile 14 includes constraints. Once the user profile 14 is stored on the mobile NFC reading device 10, the method 30 may include Step 34 of establishing a communication between the mobile NFC device 10 and an NFC tag 14 coupled to an item for sale. The method 30 may include Step 36 of receiving item information stored on the NFC tag 22 by the mobile NFC reading device 10, wherein the item information corresponds to the item for sale. Once the item information is received, the method 30 may include Step 38 of processing the item information received by the mobile NFC reading device, wherein processing the item comprises executing software logic stored in the memory of the mobile NFC reading device, and comparing the item information with the user profile. The method 30 may also include Step 40 of notifying a user in response to a determination that the item information is or is not within the constraints of the user profile.

The method 30 further includes performing the method independent of a network connection. Additionally, the method includes displaying an alternative item on a display of the mobile NFC reading device 10 in response to the determination that the item information is not within the constraints of the user profile 14.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific preferred embodiments, it should be understood by those skilled in the art that various changes in form and detail may be made therein without departing from the spirit and scope of the invention as defined by the following claims.

What is claimed is:

1. A system for personalized shopping, the system comprising:
a mobile NFC reading device comprising a memory and a processor, wherein the memory stores a user profile having constraints and software logic; and
an NFC tag corresponding to an item for sale, the NFC tag comprising item information of the item for sale and located adjacent to or on the item for sale; wherein
the mobile NFC reading device communicates with NFC tag to receive the item information;
the processor of mobile NFC reading device executes the software logic to process the item information and compare the item information with the user profile; and
the mobile NFC reading device notifies a user in response to a determination that the item information is not within the constraints of the user profile.

2. The system of claim 1, wherein the item is a food product.

3. The system of claim 2, wherein the user profile comprises ingredients of food products that interfered with prescription medication.

4. The system of claim 2, wherein the user profile comprises ingredients of food products that the user is allergic to.

5. The system of claim 2, wherein the user profile comprises dietary restrictions.

6. The system of claim 2, wherein the user profile comprises financial constraints.

7. The system of claim 1, wherein the item is a prescription medication.

8. The system of claim 7, wherein the user profile comprises insurance information.

9. The system of claim 7, wherein the user profile comprises current medications of the user.

10. The system of claim 1, wherein the mobile NFC reading device operates independent of a network connection.

11. The system of claim 1, wherein the NFC tag operates independent of a network connection.

12. The system of claim 1, wherein the user profile is encrypted on the mobile NFC reading device memory.

13. The system of claim 1, wherein mobile NFC reading device displays an alternative item on a display of the mobile NFC reading device in response to the determination that the item information is not within the constraints of the user profile.

14. A method of personalized shopping, the method comprising:
storing a user profile in a memory of a mobile NFC reading device, wherein the user profile includes constraints;
establishing a communication between the mobile NFC device and an NFC tag coupled to an item for sale;
receiving item information stored on the NFC tag by the mobile NFC reading device, wherein the item information corresponds to the item for sale;
processing the item information received by the mobile NFC reading device, wherein processing the item comprises executing software logic stored in the memory of the mobile NFC reading device, and comparing the item information with the user profile; and
notifying a user in response to a determination that the item information is or is not within the constraints of the user profile.

15. The method of claim 14, wherein the item for sale is a food product and the item information comprises ingredients of the food product and a cost of the item.

16. The method of claim 15, wherein the user profile comprises one of ingredients of food products that interfere with prescription medication; ingredients of food products that the user is allergic to; dietary restrictions; financial constraints and combinations thereof.

17. The method of claim 14, wherein the item is a prescription medication.

18. The method of claim 17, wherein the user profile comprises one of insurance information; current medications of the user; and combinations thereof.

19. The method of claim 14, further comprising performing the method independent of a network connection.

20. The method of claim 14, further comprising displaying an alternative item on a display of the mobile NFC reading device in response to the determination that the item information is not within the constraints of the user profile.
